(19) United States
(12) Patent Application Publication
(10) Pub. No.: US 2023/0204135 A1
(43) Pub. Date: Jun. 29, 2023

(54) PRESS CONNECTION SYSTEM WITH FITTINGS, A PRESS TOOL, INSERTS THEREFORE AND A TUBING SYSTEM

(71) Applicant: CONEX UNIVERSAL LIMITED, Kingswinford, West Midlands (GB)

(72) Inventors: Alan Richard GLAZE, Bromsgrove, Worcestershire (GB); Luke BROWN, Kingswinford, West Midlands (GB)

(73) Assignee: CONEX UNIVERSAL LIMITED, Kingswinford, West Midlands (GB)

(21) Appl. No.: 17/912,288

(22) PCT Filed: Mar. 16, 2021
(86) PCT No.: PCT/EP2021/056690

§ 371 Date: Sep. 16, 2022

(30) Foreign Application Priority Data
Mar. 18, 2020 (DE) 10 2020 107 498.0

(51) Int. Cl. F16L 13/14; B25B 27/10

(52) U.S. Cl. CPC F16L 13/142; B25B 27/10; F16L 2013/145

(57) ABSTRACT

A press connection system comprises a press tool (50, 60), a fitting (1) and at least a first tube (2) of a first tube diameter (R13), the press tool (50) to act with force on a deformation zone (3) of the fitting (1). The deformation zone (3) is pressed either on first tube (2) of a first tube diameter (R13) or to a second tube (2) of a second tube diameter (R23), the second tube diameter (R23) being smaller than the first tube diameter (R13). Further, a press tool, inserts therefore and a tubing system and the use of these enable to connect tubes of more than one diameter to the fitting.

### TECHNICAL FIELD

The invention relates to a press connection system with fittings, a press tool, inserts therefore and a tubing system. Fittings are used to connect sections of pipes or tubes as part of a tubing system. Pressed connections need a mechanical or electrical press tool to deform the fitting and press or crimp the fitting to a tube inserted in the fitting. To enable multiple diameters of tubing systems, press tools can have inserts adapted to different diameters of the fittings and the tubes.

### BACKGROUND ART

EP 3 015 751 discloses a fitting for connecting to a tubular element by a tubing connection created by a deformation of the fitting with a press tool. In general, each fitting is designed to match with a specific diameter of the tubes of the tubing system and it is necessary to provide for each specific diameter of a tube a corresponding fitting.

Especially in the two major systems with imperial sizes and metric sizes of tubing systems it is common to require the use of either imperial or metric fittings and the corresponding press tools with press parts. For example, a ¾″ press fitting is used with ¾″ press parts of a press tool on a fitting for a ¾″ tube diameter. For a 18 mm tube diameter, a 18 mm press fitting with a press tool for 18 mm is used.

This leads to many different parts to be provided and stocked to serve the needs in all diameters.

### DISCLOSURE OF INVENTION

Following a first invention, a press connection system comprises a press tool, a fitting and at least a first tube, the press tool having at least two parts which can be moved relative to each other from a wide position B in close contact with a deformation zone on the fitting arranged between the parts to a narrow position C to act with force on the deformation zone of the fitting. To create a secure mechanical connection between the fitting and the first tube, the parts are designed for pressing the deformation zone of a first outer fitting diameter and of a first inner fitting diameter on the first tube of a first tube diameter inserted in the fitting. To be able to insert the first tube in the fitting, the first tube diameter is smaller than the first inner fitting diameter.

The press connection system is such, that the deformation zone of the fitting with the first outer fitting diameter is pressed either on a first tube of a first tube diameter or to a second tube of a second tube diameter, the second tube diameter being smaller than the first tube diameter.

The main purpose of the concept is to use the same fitting for either a tube system with imperial tubes or for a tube system with metric tubes. Thus, the inventive concept concerns mainly the pressing of an imperial fitting onto a metric tube. With this concept, the number of fittings which have to be provided, can significantly be reduced.

In one embodiment, the difference between the first tube diameter and the second tube diameter and/or the difference between the first inner fitting diameter and the second tube diameter is between 0.015 and 1.0 mm.

If the difference in size is too big, the deformation of the deformation zone will not lead to a sufficient strong connection allowing also a tight connection with a sealing element arranged next to or within the deformation zone.

With a difference between the first tube diameter and the second tube diameter and/or the difference between the first inner fitting diameter and the second tube diameter between 0.25 and 0.95 mm, the range of the modes of use of a fitting with such a connection is further improved in view of the stability of the connection.

A further improvement can be expected if the difference between the first tube diameter and the second tube diameter and/or the difference between the first inner fitting diameter and the second tube diameter is not more than 0.76 mm.

Still further, a difference between the first tube diameter and the second tube diameter and/or the difference between the first inner fitting diameter and the second tube diameter is between 0.35 and 0.51 mm.

Preferably, to connect a tube of the second tube diameter to the fitting instead of a tube of the first tube diameter, a deformation distance of the press tool is increased. The deformation distance between the wide starting deformation position B of a diameter Ds corresponding to a loose contact with the deformation zone of the fitting and with a narrow final deformation position C of a diameter of full load contact with the deformed deformation zone to connect the fitting to a tube of the first tube diameter is not sufficient to create a press connection to connect the tube with the second tube diameter to the fitting. The deformation distance is increased at least by the amount of the difference between the difference in diameter of the first and the second tube.

To reduce the number of press tools needed, at least one of the parts of the press tool can be formed as a mother jaw with an exchangeable insert, a first insert being configured to reach a final position C to establish a press connection on a first tube of a first outer tube diameter, a second insert being designed to be placed on the fitting with a first outer fitting diameter and to reach a final position to establish a press connection on a second tube of a second outer tube diameter smaller than the first outer tube diameter.

Another aspect of the invention is directed to a press tool such as a press jaw or a press sling, having at least two parts which can be moved relative to each other to act with force on a deformation zone of a fitting arranged between the parts. The parts are arranged in a wide starting deformation position B corresponding to a loose contact with the deformation zone having a starting opening diameter Ds. At the narrow final deformation position B corresponding to a load contact with the deformed deformation zone, there is a final opening diameter Df between the parts. The press jaw or the press sling has a special geometry of a press surface, the geometry being such that it provides at least a part of an opening with an opening diameter Ds corresponding to a nominally corresponding first outer fitting diameter R11, the geometry further being such that the nominally end position C of the press jaw or the press sling for the tube of the second tube diameter R23 can be reached.

The inventors have found out, that if an imperial size fitting would be crimped to a metric size tube to be connect with the imperial fitting using a crimping tool for metric size fittings instead of for imperial size fittings, the imperial size fitting would collapse, as the imperial size fitting cannot apply the same form along the complete perimeter as a metric size fitting. Following the invention, an imperial size fitting would be crimped to a metric size tube to be connect with the imperial fitting using a crimping tool for imperial size fittings but allowing to reach an end position of a metric size fitting.

Preferably, the press tool can have a difference between the starting opening diameter Ds and a final opening diameter Df between 0.5 mm and 1.5 mm. The sufficient big difference allows to reach the final end position of the deformation zone to create a press connection.

Another invention concerns an insert of a press tool for fittings and tubes, the insert having insert connection means to be connected to corresponding connecting means of the press tool, the insert is designed for pressing a fitting of a first outer fitting diameter for a first tube of a first outer tube diameter on a second tube of a second tube diameter, the diameter of the second tube being smaller than the first outer tube diameter.

Preferably, the insert can have a special geometry of a press surface allowing pressing the fitting for a first tube of a first tube diameter on a second tube of a second tube diameter smaller than the first tube diameter, the press geometry being such that the insert provides at least a part of an opening with an opening diameter nominally corresponding to a first outer fitting diameter the insert is defined being used with and the geometry further being such that the nominally end position C of the insert for the tube of the second tube diameter can be reached.

Again, the insert allows to be placed on a first fitting with a first outer diameter as it is used for tubes of the first tube diameter although tubes of a second diameter are connected to the first fitting. To obtain a sufficient deformation of the first fitting with the second tube, the press tool has increased press distance.

To allow the exchange of the inserts, the insert can be releasable connectable to connecting means of a press tool.

Another aspect of the invention is a tubing system comprising a first tube having a first tube end of a first outer diameter, further comprising at least one fitting with a first fitting end of a first inner diameter to receive the first tube end and with a second fitting end of a second inner fitting diameter to receive another first tube end, the fitting further having a first outer diameter at the first fitting end and a second outer fitting diameter at the second fitting end, the first inner diameter of the first fitting end to receive the first tube end is the same or is substantially the same as the second inner diameter of the second fitting end, the first outer diameter of the first fitting end is the same or is substantially the same as the second outer diameter of the second fitting end, the first fitting end and the second fitting end having a radial deformation zone to fix the fitting at the first tube forming a connection between them after a deformation of the deformation zone.

To avoid the use of numerous fittings of different sizes for tubes of different sizes, instead of the first tube with a tube end of a first tube diameter, a second tube having a second tube end of a second outer diameter is provided the second tube end has a second outer diameter smaller than the first outer diameter of the first tube end and the difference between the first outer diameter of the first fitting end and/or the second outer diameter of the second fitting end outside the deformation zone on one hand and the first outer diameter of the first fitting end and/or the second outer diameter of the second fitting end within the deformation zone to connect the first tube with the first diameter to the fitting on the other hand is increased at least by the amount of the difference between the difference in diameter of the first and the second tube end to connect the tube with the second tube diameter to the fitting.

Preferably, the difference between the first outer diameter of the first tube end and the second outer diameter of the second tube end can be between 0.1 mm and 1.0 mm.

Still another object of the invention is the use of a fitting and of a first and a second tube to be connected with the fitting, the first tube having a first tube end of a first outer diameter and at least a second tube having a second tube end of a second outer diameter, the fitting having a first fitting end of a first inner diameter to receive the first tube end and having a second fitting end of a second inner fitting diameter to receive the second tube end, the fitting further having a first outer diameter at the first fitting end and a second outer fitting diameter at the second fitting end, the first inner diameter of the first fitting end to receive the first tube end is the same or is substantially the same as the second inner diameter of the second fitting end to receive the second tube end, the first outer diameter of the first fitting end is the same or is substantially the same as the second outer diameter of the second fitting end, the first fitting end and the second fitting end having a radial deformation zone to fix the fitting and the first and/or the second tube together forming a connection between them after a deformation of the deformation zone. The fitting is connected to either the first tube at the first tube end of the first outer diameter or to the second tube at the second tube end of the second outer diameter, the second outer diameter of the second tube end being smaller than the first outer diameter of the first tube end.

Preferably, the fitting is adapted to receive a first tube of imperial size as well as a second tube of metric size.

The use of the fitting designed to be used with a first tube of imperial size to create a connection with a second tube of metric size allows to reduce the number of fittings which has to be provided on metric and imperial size tubing systems.

Preferably, the fitting adapted to receive a first tube of imperial size can be deformed with a press tool adapted to be placed on the fitting adapted to receive the first tube of imperial size and the press tool is used to press the fitting on a second tube of metric size inserted in the fitting at the place of the first tube of imperial size.

Preferably, the press tool can be used to obtain a final diameter Df of the press position of the press tool for a second tube of metric size inserted in the fitting which is smaller than for a first tube of imperial size inserted in the fitting.

Preferably, the press tool is used having an exchangeable insert to provide multiple inserts with different final diameters Df in the press position C.

### BRIEF DESCRIPTION OF DRAWINGS

In the drawings the aspects of the invention are explained in detail showing different embodiments. It is shown in:

FIG. 1 a part of a fitting with a first and a second fitting end and a first and a second tube end of a first and a second tube before pressing to a connection;

FIG. 1A the first fitting end with the first tube end of the first tube

FIG. 1B the second fitting end with the second tube end of the second tube

FIG. 1C the first fitting end with the first tube end of the first tube with a first hook element

FIG. 1D the second fitting end with the second tube end of the second tube with a second hook element

FIG. 2 cross section along the lines of FIG. 1

FIG. 3 the part of a fitting of FIG. 1 after pressing to create a connection;

FIG. 4A a deformed first deformation zone after pressing with a hexagonal press geometry

FIG. 4B a deformed second deformation zone after pressing with an octagonal press geometry;

FIG. 5 a tubing system with a fitting, a first and a second tube of a different first and second tube diameter;

FIG. 6 a detail of FIG. 5;

FIG. 7 a press tool with press jaws of an approached hexagonal press geometry;

FIG. 8 the press tool of FIG. 7 but with inserts in mother jaws of the press tool;

FIG. 9 a press sling with press parts forming a hexagonal press geometry;

FIG. 10 a press tool in a position A for mounting on the fitting;

FIG. 11 wide closed position B of the press tool;

FIG. 12 final closed position C of the press tool.

### MODE(S) FOR CARRYING OUT THE INVENTION

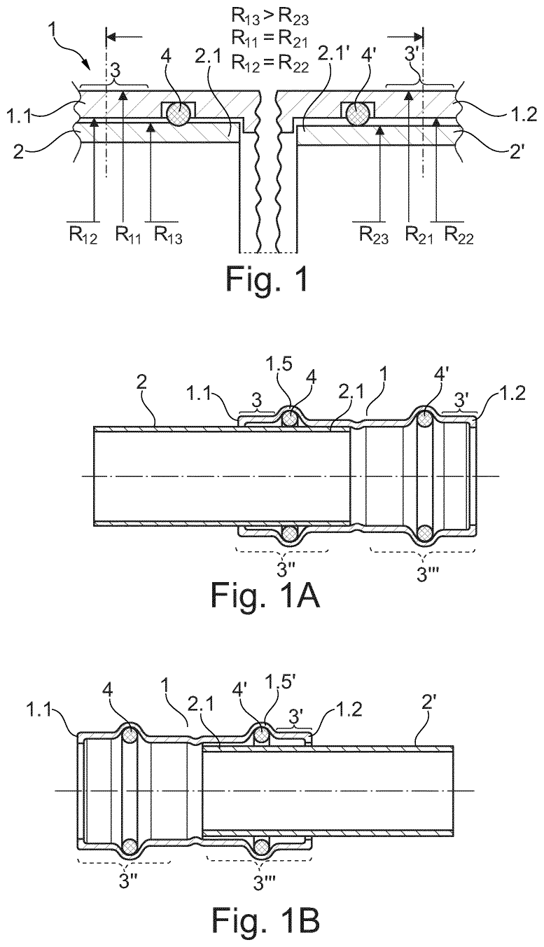

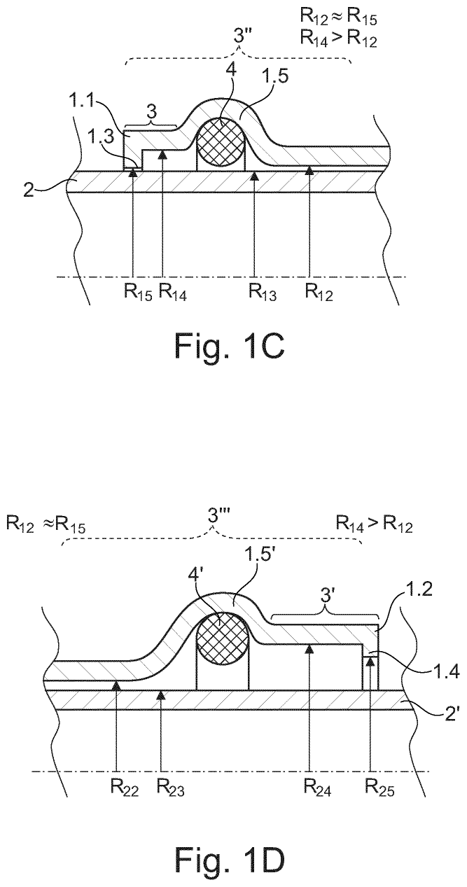

In FIG. 1 two parts of an unmounted fitting 1 as a part of a press connection system or a tubing system is shown. The fitting 1 has a first fitting end 1.1 of a first inner diameter R12 to receive a first tube 2 with its first tube end 2.1 of a first tube diameter R13 and has a second fitting end 1.2 of a second inner fitting diameter R22 to receive a second tube 2′ with a second tube end 2.1′ of a second tube diameter R23. The first inner diameter R12 of the first fitting end 1.1 to receive the first tube end 2.1 is the same or substantially the same as a second inner diameter R22 of the second fitting end 1.2 to receive the second tube end 2.1′.

In general, the first and the second tube to be connected with the two ends of the fitting 1 are of the same dimensions.

To explain the invention, another terminology is used for the first tube and the second tube: there is on one hand a combination of the fitting connected to a first type of (first) tubes and on the other hand a further combination of the fitting connected to a second type of (second) tubes, the second type of tubes being of a different size than the first type of tubes. So, in the following, the second tube is not the tube placed in the second end of the fitting, but a tube of the second type of tubes.

Although it is possible to use the same fitting with a tube of the first type and with a tube of the second type, such tubing systems are not yet common in practice.

The fitting 1 has a first outer diameter R11 at the first fitting end 1.1 and a second outer fitting diameter R21 at the second fitting end 1.2. The first outer diameter R11 of the first fitting end 1.1 is the same or substantially the same as the second outer diameter R21 of the second fitting end 1.2.

The first fitting end 1.1 and the second fitting end 1.2 have each a radial deformation zone 3, 3′ to fix the fitting 1 at the first tube 2 and at the second tube 2′ by use of a press tool, described later. The deformation zone 3, 3′ is at least on one side of a sealing element 4, 4′, but can also extend over the sealing element 4, 4′ and further parts of the fitting ends 1.1, 1.2. on the inner side in relation to the sealing element 4, 4′, as is shown later in FIG. 1A to 1D.

In FIG. 1A another form of the fitting 1 is shown with the first tube 2, that is a tube of the first type of tubes, inserted with its first tube end 2.1 of the first tube diameter in the first fitting end 1.1, the second fitting end 1.2 is of the same size, but there is no tube inserted. The fitting 1 has a deformation zone 3, which can also be extended to a large deformation zone 3′ on each side of a sealing element 4, 4′ as indicated with the dotted braces on the lower side of the figure. A bead 1.5 receives the sealing element 4 of the fitting 1 and the bead 1.5 can be deformed, to bring the sealing element 4, 4′ in sufficient close contact with the outer surface of the first tube 2.

In FIG. 1B, the fitting 1 of FIG. 1A is shown with a second tube 2′, that is a tube of the second type of tubes, a second tube end 2.1′ of a second tube diameter being inserted in the second fitting end 1.2, the first fitting end is empty. As can be seen, the second tube diameter R23 (FIG. 1) is slightly smaller than the first tube diameter R13 (FIG. 1) of the first tube 2 (FIG. 1A). As for the fitting with the first tube of FIG. 1A, the second tube 2′ can be connected to the second fitting end 1.2 by pressing on a deformation zone 3′, which can be arranged on the outwards side of the sealing element 4′ or which can also be extended to a large deformation zone 3′ on each side of a sealing element 4, 4′ as indicated with the dotted braces on the lower side of the figure.

FIG. 1C shows a detail of FIG. 1A to explain the deformation zone 3, 3″ and a special characteristic of the fitting end 1.1 is a hook element 1.3 at the outer end of the fitting end 1.1. The hook element 1.3 extends radially inwards from the fitting end 1.1 and the hook element ends with a diameter R15 which corresponds to the inner fitting diameter R12 of the fitting end 1.1 on its part extending from the sealing element 4 inwardly. As can be seen in the drawing, the part of the fitting end 1.1 extending from the sealing element 4 outwardly has a bigger diameter R14 compared to the part extending from the sealing element 4 inwardly with the diameter R12. After the deformation of the deformation zone 3, 3″ by pressing with a press tool (see below), the hook element 1.3 is pressed in the first tube 2 and creates a positive engagement of the connection (not shown). If the bead 1.5 is pressed too, the sealing element 4 is pressed against the first tube 2 which results in a tight connection even with higher pressure of 48 bar.

The hook element with the diameter R15, the sealing element 4 and the part extending from the sealing element 4 inwardly with the diameter R12 are in close contact with the surface of the first tube 2.

As can be seen in FIG. 1D, the surface of the second tube 2′ with a second tube diameter R23 has a significant distance to the second fitting end 1.2, since the diameters R22, R24 and R25 of the second fitting end are the same as in FIG. 1C, whereas the second tube diameter R23 is smaller than the first tube diameter R13 (FIG. 1C). After the deformation of the deformation zone 3′, 3′ by pressing with a press tool, this distance disappears and the mechanical connection and the sealing function can be achieved. Since the sealing element has be in a sufficient contact with the second tube 2′, the deformation zone 3′ can be enlarged to the deformation zone 3′″ including the deformation of the bead 1.5′.

As can be easily understood, the press tool has to be brought in a more narrow end position as in FIG. 1C to obtain the mechanical connection and the tightness of the connection, see further description below.

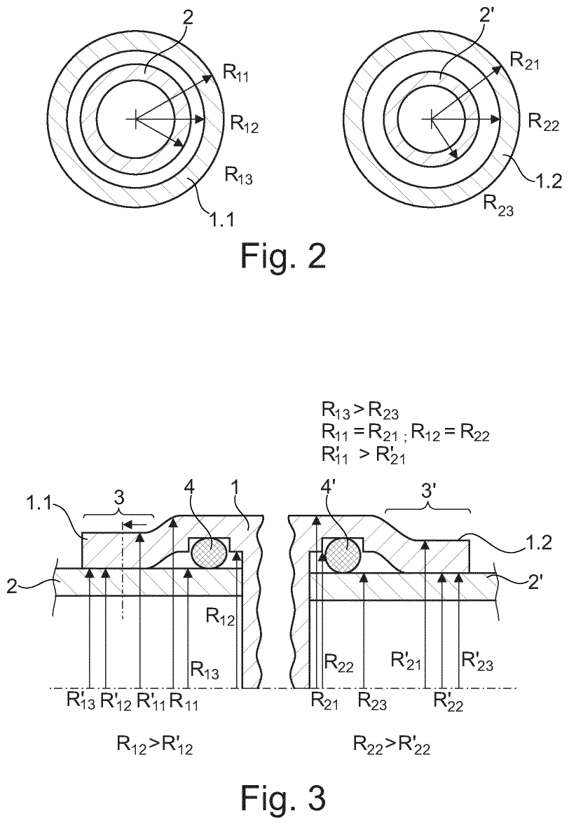

FIG. 2 shows a cross section along the lines of FIG. 1. On the left side of FIG. 2 the fitting end 1.1 has a first outer fitting diameter R11 and a first inner fitting diameter R12, the inserted first tube 2 has the first tube diameter R13, which is the outer tube diameter. This tube diameter can be a diameter of the so called imperial size tubes with usual sizes of for example ¼″, ½″, ⅝″, ¾″, 1.0″, 1⅛″, 1⅜″, 1¼″, 1½″, 1¾″, 2.0″, 2⅛″, 2½″, 3.0″, 3½″, 4.0″, and so on.

On the right side of FIG. 2 the fitting end 1.2 has a second outer fitting diameter R21 and a second inner fitting diameter R22, which correspond to the diameters of the fitting on the left side. The inserted second tube 2′ has the second tube diameter R23, which is the outer tube diameter. This tube diameter can be a diameter of the so called metric tubes with usual sizes of for example 6 mm, 8 mm, 10 mm, 12 mm, 15 mm, 16 mm, 18 mm, 22 mm, 28 mm, 35 mm, 54 mm and so on.

Again, it is pointed out that the in the common practice of tubing systems there is no combination of imperial size tubes with metric size tubes, although the fitting of the invention would allow such a combination in certain cases.

FIG. 3 shows exemplary the fitting 1 of FIG. 1 after pressing on the deformation zone 3, 3′ to create a secure mechanical connection with a first tube (left side of the fig.) or with a second tube (right side of the fig.). Starting with the left side of FIG. 3, the deformation zone 3 of the first fitting end 1.1 is reduced from the first outer fitting diameter R11 to a first reduced fitting diameter R11′ and the first inner fitting diameter R12 is reduced to a first reduced inner fitting diameter R12′. In the deformation zone 3, the first tube end diameter R13 is also reduced to a reduced first tube end diameter R13′.

On the right side of FIG. 3, the deformation zone 3′ of the second fitting end 1.2 is reduced from the second outer fitting diameter R21 to a second reduced fitting diameter R21′ and the second inner fitting diameter R22 is reduced to a second reduced inner fitting diameter R22′. In the deformation zone 3′, the second tube end diameter R23 is also reduced to a reduced second tube end diameter R23′.

Since the fitting 1 is intended to be used with the first tube 2 and/or with the second tube 2′, the first outer fitting diameter R11 is the same as the second outer fitting diameter R21 and the same for the inner fitting diameter R12 and R22. The difference between the first reduced fitting diameter R11′ and the second reduced inner fitting diameter R22′ is related to the difference of the first tube end diameter R13 and the second tube end diameter R23. In general, the difference between the first reduced fitting diameter R11′ and the second reduced inner fitting diameter R22′ is equal to the difference of the first tube end diameter R13 and the second tube end diameter R23, which leads to a bigger change of the second reduced fitting end diameter compared to the second fitting diameter than the change of the first reduced fitting end diameter compared to the first fitting diameter.

Although the fitting end 1.1, 1.2 experiences more deformation connecting the fitting 1 to the second tube 2′ than connecting the fitting 1 to the first tube 2, the amount of the deformation is still not more to maintain that the mechanical connection is sufficiently strong.

Other than shown in FIG. 3, it is appropriate to extend the deformation zone 3, 3′ over the sealing element 4, 4′ as shown in FIG. 1A-D, to ensure that the sealing element 4, 4′ remains in a tight contact with the first or the second tubes 2, 2′.

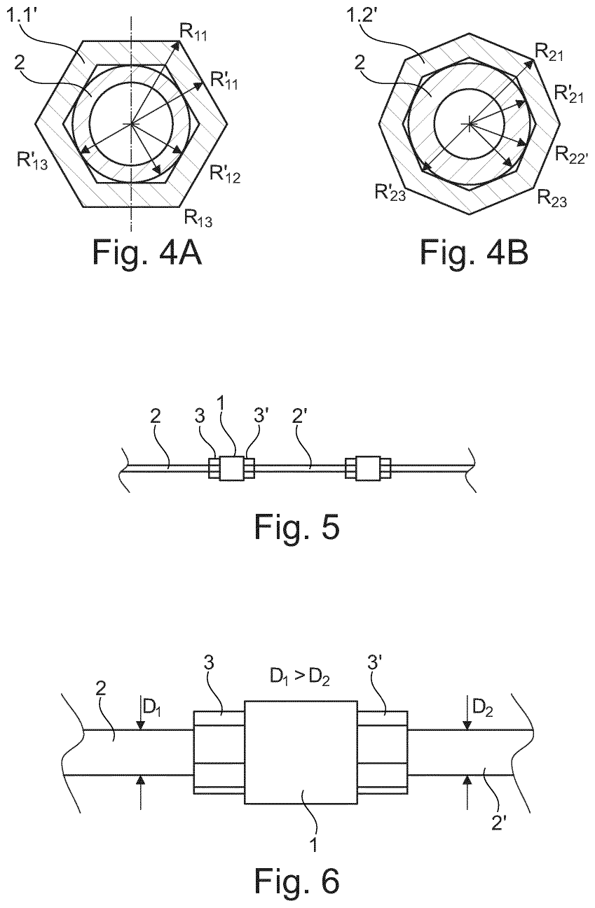

FIG. 4A shows the section of FIG. 2 after the deformation of the first deformation zone 3 of a fitting end 1.1′ with the inserted first tube 2 by pressing the deformation zone 3 with a hexagonal press geometry. The first outer fitting diameter R11 is reduced to the first reduced fitting diameter R11′, the first inner fitting diameter R12 (FIG. 2) is reduced to the first reduced inner fitting diameter R12′. The first tube diameter R13 is reduced to a reduced first tube diameter R13′ at points of intimate contact with the deformed fitting end 1.1′.

FIG. 4B shows the section of FIG. 2 after the deformation of the second deformation zone 3′ of a fitting end 1.2′ with the inserted second tube 2′ by pressing the deformation zone 3′ with an octagonal press geometry. The second outer fitting diameter R21 is reduced to the second reduced fitting diameter R21′, the second inner fitting diameter R22 (FIG. 2) is reduced to the second reduced inner fitting diameter R22′. The second tube diameter R23 is reduced to a reduced second tube diameter R23′ at points of intimate contact with the deformed fitting end 1.1′.

FIG. 5 shows a tubing system 20 with a fitting 1 connecting the first and the second tube 2, 2′ by a deformation zone 3, 3′ of the fitting 1. The fitting 1 is of such a kind that both ends of the fitting are identical and can receive the first and second tubes 2, 2′.

FIG. 6 shows the fitting 1 of FIG. 5 in a detail. Although the fitting 1 has identical ends, the fitting 1 can be deformed in the deformation zone 3, 3′ to either a first tube 2 or either a second tube 2′. Therefore, both ends of the fitting can receive first or second tubes 2, 2′ to connect to each other. The first tube 2 has a diameter D1 and the second tube 2′ has a diameter D2 being smaller than the diameter D1 of the first tube 2. The fitting 1 can be used for first tubes only, for second tubes only or even for a mixture of first and second tubes.

It is worth to note that each tube diameter corresponds with a special press geometry of the press jaw to allow placing the press tool on the fitting and to press the fitting on the tube until reaching a final press position C, see FIG. 12.

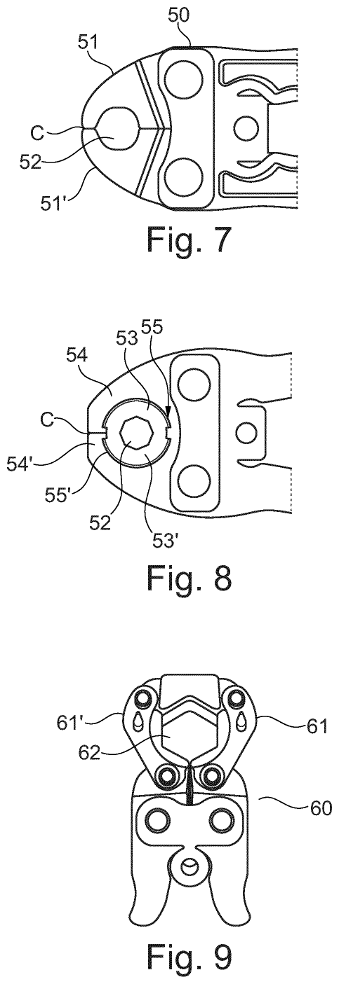

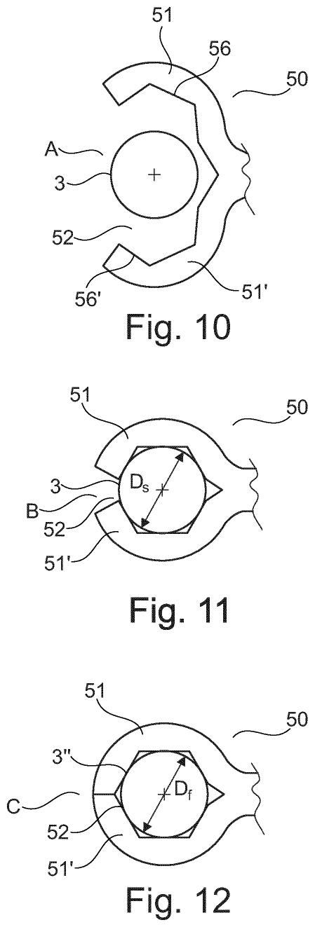

FIG. 7 shows a press tool 50 with press parts being press jaws 51, 51′ enclosing an opening 52 of an approached hexagonal press geometry in a closed position C (FIG. 12). The press jaws 51, 51′ can be opened in a wide opened position A to give access to the opening 52, see FIG. 10. Those press tools are known in the state of the art.

FIG. 8 shows the press tool of FIG. 7 but instead of the press jaws 51, 51′, the press tool 50 has inserts 53, 53′ arranged in mother jaws 54, 54′ with a receiving geometry 55, 55′ for the inserts 53, 53′. Those press tools are known in the state of the art.

FIG. 9 shows a press sling 60 with press parts 61, 61′ forming a hexagonal press geometry of the opening 62. Those press slings are used for bigger sizes of tubes. Such a press sling 60 is known in the state of the art.

FIG. 10 shows the press tool 50 with the press jaws 51, 51′ wide open in a position A for mounting on the deformation zone 3 of the fitting. The opening 52 is partially delimited by the hexagonal geometry 56, 56′ of the press jaws 51, 51′.

FIG. 11 shows a narrow closed position B of the press tool, the press jaws 51, 51′ are in close contact with the deformation zone 3 of the fitting. The opening 52 is not closed yet.

FIG. 12 shows a final closed position C of the press tool, the press jaws 51, 51′ are in close contact with each other and the opening 52 is closed. The deformation zone 3 (FIG. 11) of the fitting has been deformed and the result is the deformation zone 3″ approaching the press geometry of the press jaws. After release of the press tool, the fitting with the tube have the shape as set out in FIG. 4A.

The process of creating a press connection between a fitting and a tube as described in the FIGS. 10 to 12 is known in the state of the art.

To provide a tubing system, at least a first tube having a first tube end of a first outer diameter is connected to at least one fitting with a first fitting end of a first inner diameter to receive the first tube. The fitting has a second fitting end of a second inner diameter, the first inner diameter of the first fitting end to receive the first tube end is substantially the same as the second inner diameter of the second fitting end which is able to receive the first tube. F

The first fitting end and the second fitting end have a radial deformation zone to fix the fitting and the tube together forming after the deformation of the deformation zone a connection between them.

Following the invention, it is not the first tube which is used to provide the tubing system, but it is a second tube with a second tube end which is connected to the first fitting end and to the second fitting end. There is a difference between the first outer diameter of the first tube end and the second outer diameter of the second tube end. Thus, in a more practical definition, what is different in the invention is the fact, that the same fitting designed for a connection with an imperial size tube is used to be connected with a metric tube.

To obtain a secure connection, the press geometry of the press tool and the final end position of the press tool is different for pressing the fitting an a tube with imperial size and for pressing the same fitting on a smaller tube of metric size.

As an example, a standard fitting of ½″ imperial size, that is 12.7 mm, would be used with a standard tube of ½″ imperial size as in the state of the art, but the same fitting can be used with a metric size tube of 12 mm metric which is inserted in the fitting at the place of the imperial size tube. The difference between the ½″ imperial size and 12 mm metric size is 0.7 mm and the press tool has to press the imperial size fitting of ½″ on the metric tube of 12 mm with at least this supplemental distance of 0.7 mm compared to a press tool pressing the imperial size fitting of ½″ to an imperial size tube of ½″.

It should be understood that the diameters are the nominal diameters including the regular tolerances of production.

### LIST OF REFERENCE SIGNS

1 fitting
1.1 first fitting end
1.2 second fitting end
1.3 first hook element
1.4 second hook element
1.5 sealing element support (bead)
1.5′ sealing element support (bead)
2 first tube
2.1 first tube end
2′ second tube
2.1′ second tube end
3 deformation zone of the first fitting end
3′ deformation zone of the second fitting end
3″ enlarged deformation zone of the first fitting end
3′″ enlarged deformation zone of the second fitting end
4 sealing element
4′ sealing element
50 press tool
51 press jaw, part of a press jaw
51′ press jaw, part of a press jaw
52 opening
53 insert
53′ insert
54 mother jaw
54′ mother jaw
55 insert connection means
55′ connecting means of the press tool
56 press geometry
56′ press geometry
60 press sling
61 press parts
61′ press parts
62 opening
A wide open position to mount the press tool
B starting deformation position of press tool
C narrow (closed) final deformation position of press tool
D1 first tube diameter
D2 second tube diameter
R11 first outer fitting diameter
R12 first inner fitting diameter
R13 first (outer) tube diameter,
R13′ first (outer) tube end diameter
R14 diameter of the part of the first fitting end
R15 hook element diameter
R21 second outer fitting diameter
R22 second inner fitting diameter
R23 second outer tube diameter
R23′ second outer tube end diameter
R24 diameter of the part of the second fitting end
R25 hook element diameter
Ds starting opening diameter of press tool
Df final opening diameter of press tool on deformation zone

1. A press connection system, comprising a press tool, a fitting and at least a first tube of a first tube diameter, the press tool having at least two parts which can be moved relative to each other from a wide position to a narrow position to act with force on a deformation zone of the fitting arranged between the parts, the parts being designed for pressing the deformation zone of a first outer fitting diameter and of a first inner fitting diameter on the first tube of a first tube diameter, the first tube diameter being smaller than the first inner fitting diameter, the deformation zone of the fitting with the first outer fitting diameter being pressed either on a first tube of a first tube diameter or to a second tube of a second tube diameter, the second tube diameter being smaller than the first tube diameter.

2. The press connection system of claim 1, wherein the difference between the first tube diameter and the second tube diameter and/or wherein the difference between the first inner fitting diameter and the second tube diameter is between 0.015 and 1.0 mm.

3. The press connection system of claim 2, wherein the difference between the first tube diameter and the second tube diameter and/or wherein the difference between the first inner fitting diameter and the second tube diameter is between 0.25 and 0.95 mm.

4. The press connection system of claim 2, wherein the difference between the first tube diameter and the second tube diameter and/or wherein the difference between the first inner fitting diameter and the second tube diameter is not more than 0.76 mm.

5. The press connection system of claim 2, wherein the difference between the first tube diameter and the second tube diameter and/or wherein the difference between the first inner fitting diameter and the second tube diameter is between 0.35 and 0.51 mm.

6. The press connection system of claim 1, wherein to connect a tube of the second tube diameter to the fitting instead of a tube of the first tube diameter, a deformation distance of the press tool between the wide starting deformation position of a diameter corresponding to a loose contact with the deformation zone of the fitting and with a narrow final deformation position of a diameter of full load contact with the deformed deformation zone to connect the fitting to a tube of the first tube diameter is increased to connect the tube with the second tube diameter to the fitting at least by the amount of the difference between the difference in diameter of the first and the second tube.

7. The press connection system of claim 1, wherein at least one of the parts of the press tool is formed as a mother jaw with an exchangeable insert, a first insert being configured to reach a final position to establish a press connection on a first tube of a first outer tube diameter, a second insert being designed to be placed on the fitting with a first outer fitting diameter and to reach a final position to establish a press connection on a second tube of a second outer tube diameter smaller than the first outer tube diameter.

8. A press tool being either a press jaw or a press sling, having at least two parts which can be moved relative to each other to act with force on a deformation zone of a fitting arranged between the parts, the parts arranged in a wide starting deformation position corresponding to a loose contact with the deformation zone having a starting opening diameter and a final opening diameter (Df) at the narrow final deformation position corresponding to a load contact with the deformed deformation zone, wherein the press jaw or the press sling has a special geometry of a press surface, the geometry being such that it provides at least a part of an opening with an opening diameter corresponding to a nominally corresponding first outer fitting diameter, the geometry further being such that the nominally end position of the press jaw or the press sling for the tube of the second tube diameter can be reached.

9. The press tool according to claim 8, wherein the difference between the starting opening diameter and a final opening diameter is between 0.5 mm and 1.5 mm.

10. An insert of a press tool for fittings and tubes as in claim 7, the insert having insert connection means to be connected to corresponding connecting means of the press tool, the insert is designed for pressing a fitting of a first outer fitting diameter for a first tube of a first outer tube diameter, characterized by the insert is further designed for pressing the fitting on a second tube of a second tube diameter smaller than the first outer tube diameter.

11. The insert of claim 10, wherein the insert is releasable connectable to connecting means of a press tool.

12. The insert of claim 10, wherein the insert has a special geometry of a press surface allowing pressing the fitting for a first tube of a first tube diameter on a second tube of a second tube diameter smaller than the first tube diameter, the press geometry being such that the insert provides at least a part of an opening with an opening diameter nominally corresponding to a first outer fitting diameter the insert is defined being used with and the press geometry further being such that the nominally end position of the insert for the tube of the second tube diameter can be reached.

13. A tubing system comprising a first tube having a first tube end of a first outer diameter, further comprising at least one fitting with a first fitting end of a first inner diameter to receive the first tube end and with a second fitting end of a second inner fitting diameter to receive another first tube end, the fitting further having a first outer diameter at the first fitting end and a second outer fitting diameter at the second fitting end, the first inner diameter of the first fitting end to receive the first tube end is the same or is substantially the same as the second inner diameter of the second fitting end, the first outer diameter of the first fitting end is the same or is substantially the same as the second outer diameter of the second fitting end, the first fitting end and the second fitting end having a radial deformation zone to fix the fitting at the first tube forming a connection between them after a deformation of the deformation zone,
wherein:
instead of the first tube with a tube end of a first tube diameter a second tube having a second tube end of a second outer diameter is provided;
the second tube end has a second outer diameter smaller than the first outer diameter of the first tube end;
the difference between the first outer diameter of the first fitting end and/or the second outer diameter of the second fitting end outside the deformation zone on one hand and the first outer diameter of the first fitting end and/or the second outer diameter of the second fitting end within the deformation zone to connect the first tube with the first diameter to the fitting on the other hand is increased to connect the tube with the second tube diameter to the fitting at least by the amount of the difference between the difference in diameter of the first and the second tube end.

14. The tubing system of claim 13, wherein the difference between the first outer diameter of the first tube end and the second outer diameter of the second tube end being between 0.1 mm and 1.0 mm.

15. Use of a fitting and of a first and a second tube to be connected with the fitting, the first tube having a first tube end of a first outer diameter and at least a second tube having a second tube end of a second outer diameter, the fitting having a first fitting end of a first inner diameter to receive the first tube end and having a second fitting end of a second inner fitting diameter to receive the second tube end, the fitting further having a first outer diameter at the first fitting end and a second outer fitting diameter at the second fitting end, the first inner diameter of the first fitting end to receive the first tube end is the same or is substantially the same as the second inner diameter of the second fitting end to receive the second tube end, the first outer diameter of the first fitting end is the same or is substantially the same as the second outer diameter of the second fitting end, the first fitting end and the second fitting end having a radial deformation zone to fix the fitting and the first and/or the second tube together forming a connection between them after a deformation of the deformation zone, wherein the fitting is connected to either the first tube at the first tube end of the first outer diameter or to the second tube at the second tube end of the second outer diameter, the second outer diameter of the second tube end being smaller than the first outer diameter of the first tube end.

16. Use of a fitting and a tube as defined in claim 15, wherein the fitting is adapted to receive a first tube of imperial size as well as a second tube of metric size.

17. Use of the fitting and a tube to provide a tubing system of claim 15, wherein the fitting adapted to receive a first tube of imperial size is deformed with a press tool adapted to be placed on the fitting adapted to receive the first tube of imperial size and to press the fitting on a second tube of metric size inserted in the fitting at the place of the first tube of imperial size.

18. Use of the fitting of claim 17, wherein the final diameter of the press position of the press tool for a second tube of metric size inserted in the fitting is smaller than for a first tube of imperial size inserted in the fitting.

19. Use of a fitting and a tube of claim 18, wherein the press tool is used having an exchangeable insert to provide multiple inserts with different final diameters in the press position.

20. Use of a fitting and a tube of claim 19, wherein the difference between the second outer diameter of the second tube end on one hand and the first outer diameter of the first tube end on the other hand is between 0.1 mm and 1.0 mm.
